(19) United States
(12) Patent Application Publication
(10) Pub. No.: US 2015/0021498 A1
(43) Pub. Date: Jan. 22, 2015

(54) CHEMICAL MECHANICAL POLISHING RETAINING RING METHODS AND APPARATUS

(71) Applicant: Applied Materials, Inc., Santa Clara, CA (US)

(72) Inventors: Samuel Hsu, Palo Alto, CA (US); Jeonghoon Oh, San Jose, CA (US); Gautam Dandavate, Sunnyvale, CA (US); Hung Chen, Sunnyvale, CA (US)

(21) Appl. No.: 13/944,204

(22) Filed: Jul. 17, 2013

(51) Int. Cl. B24B 37/32; G21K 5/00; B24C 1/10

(52) U.S. Cl. CPC B24B 37/32; B24C 1/10; G21K 5/00
USPC 250/492.1; 451/38; 156/345.14

(57) ABSTRACT

A chemical mechanical polishing (CMP) system includes a substrate held in a substrate holder having a substrate retaining ring, the substrate having a peripheral edge supported by the substrate retaining ring, the retaining ring including a polymer ring having a polymer contact portion in contact with at least a portion of the peripheral edge, wherein the polymer contact portion has a hardness that is greater than a remaining portion of the polymer ring. CMP methods and retaining ring apparatus for CMP are provided, as are numerous other aspects.

### FIELD

The present invention relates generally to electronic device manufacturing, and more particularly to chemical mechanical polishing.

### BACKGROUND

Within electronic device manufacturing, a planarization process may be used to remove various layers or films, such as silicon dioxide, silicon nitride, copper, or the like from a substrate (e.g., a patterned wafer). Planarization may be accomplished using a chemical mechanical polishing (CMP) process by applying an abrasive slurry between a polishing pad and the substrate surface to be polished (e.g., planarized). The substrate is received in a substrate holder that includes a retaining ring adapted to prevent the substrate from slipping out from between the holder and the polishing pad. Pressure is applied to force the substrate against the polishing pad and both the substrate holder and the polishing pad may be rotated to facilitate the material removal. Further, the holder may oscillate the substrate back and forth across the surface of the polishing pad.

During certain planarization processes, although sufficient material removal may be accomplished with existing processes, unwanted wear of the substrate holder may occur. Accordingly, improved polishing methods and apparatus are sought.

### SUMMARY

In a first aspect, a chemical mechanical polishing method is provided. The chemical mechanical polishing method includes providing a substrate retaining ring including a polymer ring having a polymer surface adapted to contact a substrate while in operation; and treating the surface of the polymer ring to attain an increased hardness of the surface as compared to other regions of the polymer ring.

In another aspect, a chemical mechanical polishing system is provided. The chemical mechanical polishing system includes a substrate held in a substrate holder having a substrate retaining ring, the substrate having a peripheral edge supported by the substrate retaining ring, the retaining ring having a polymer ring having a polymer contact portion in contact with at least a portion of the peripheral edge, wherein the polymer contact portion has a hardness that is greater than a remaining portion of the polymer ring.

In yet another aspect, a chemical mechanical polishing substrate holder is provided. The chemical mechanical polishing substrate holder includes a substrate retaining ring configured to support a peripheral edge of a substrate, the retaining ring including a polymer ring having a polymer contact portion adapted to contact at least a portion of the peripheral edge, wherein the polymer contact portion has a hardness that is greater than a remaining portion of the polymer ring.

Other features and aspects of the present invention will become more fully apparent from the following detailed description of example embodiments, the appended claims, and the accompanying drawings.

### BRIEF DESCRIPTION OF THE DRAWINGS

FIG. 1 illustrates a partial side plan of a chemical mechanical polishing system including an improved substrate holder according to some embodiments of the present invention.

FIGS. 2A and 2B illustrate a perspective view and a top plan view, respectively, of a retaining ring for a substrate holder according to some embodiments of the present invention.

FIG. 3 illustrates a cross-sectioned side view of a substrate holder according to some embodiments of the present invention.

FIG. 4 illustrates an example graph of Barcol hardness versus ultraviolet (UV) light exposure time.

FIG. 5 illustrates an example graph of Barcol hardness versus bead blast time.

FIG. 6 illustrates a flowchart of a chemical mechanical polishing method according to some embodiments of the present invention.

### DETAILED DESCRIPTION

Embodiments described herein relate to systems and methods adapted to polish the surface and edge of a substrate. While the major surface of the substrate is polished directly by the pad, removal of material from the edge of the substrate can be influenced using the retaining ring of the substrate holder. Pressures applied to the polishing pad through the retaining ring can be selected so that the substrate edge removal rate is controlled. However, selecting relatively low pressures to reduce wear can be problematic. A retaining ring on a polishing head is subjected to at least two wear mechanisms: vertical wear and lateral wear. Vertical wear of the ring refers to wear normal to the lower contact surface between the ring and the polishing pad (i.e., the retaining ring surface facing the polishing pad). If possible, it would be desirable to reduce or avoid vertical wear by using lower pressures. Lateral, or horizontal, wear of the ring refers to wear from the substrate edge resulting from friction during polishing.

Lateral wear results in “notching” of the retaining ring if the pressure applied to the polishing pad through the retaining ring is too low. If notching is allowed to occur, the edge of the substrate may undesirably be subjected to the downward pressure from the retaining ring which affects substrate edge removal rates and risks substrate slipping. Increasing the pressure applied to the polishing pad through the retaining ring can effectively be used to remove or prevent notching but at the expense of increasing the amount of vertical wear. In other words, using a conventional substrate holder, it is necessary to have sufficient vertical wear to ensure that damage resulting from lateral wear (or wafer notching) is removed to provide proper retention of the substrate within the holder.

In some embodiments, the present invention reduces the need to apply a relatively large amount of pressure to the polishing pad through the retaining ring. By increasing the hardness of the inner diameter of the retaining ring, the retaining ring is better able to resist substrate notching, even at lower retaining ring pressures during substrate polishing. In some embodiments, the inner surface of the retaining ring is treated to achieve the increased hardness. For example, in the case where the retaining ring is constructed of a polymer material, the treatments can include ultraviolet (UV) light curing and bead blasting. Other methods such as cold rolling, vulcanization, application of a laminate, laser hardening, and electron beam curing can also be used. Other well-known hardening methods may be used for polymer rings and for retaining rings made of other materials. In some embodiments, the hardness and/or depth of the hardening is selected to ensure notching cannot occur at any practicable retaining ring pressure.

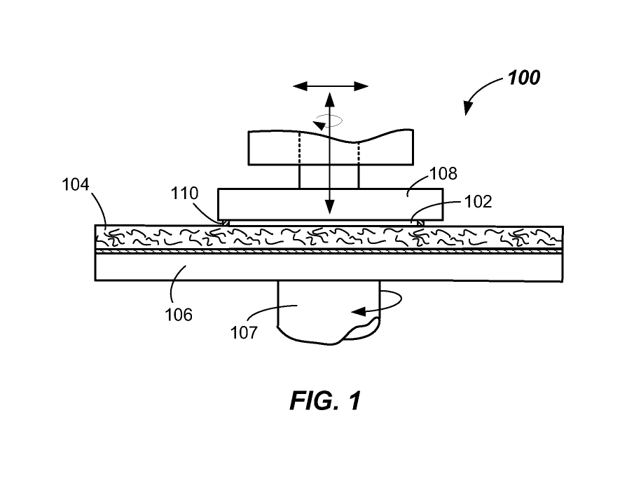

These and other aspects of embodiments of the invention are described below with reference to FIGS. 1-6 herein.

FIG. 1 illustrates a partial side view of a chemical mechanical polishing (CMP) system 100 and components thereof. The CMP system 100 is adapted to hold a substrate 102 in relationship to a polishing pad 104, and is used to carry out a polishing process in accordance with aspects of the invention. The substrate 102 may be a wafer, such as a patterned wafer including partially-formed transistors or patterns formed thereon. The substrate 102 may include a silicon-containing base having a metal-containing layer deposited thereon. The metal layer may have been previously deposited onto the silicon surface such as by a deposition process.

The polishing pad 104 may be of conventional construction, and may comprise any suitable porous material such as a rigid micro-porous polyurethane pad. The polishing pad 104 may be mounted (e.g., adhered) onto a conventional platen 106 that may be rotated by a suitable motor (not shown) coupled to the platen 106 by shaft 107. In some embodiments, polishing pad 104 may have a shore D hardness per ASTM D2240 of between about 30 and about 70, and between about 52 and about 62 in some embodiments. The polishing pad 104 may have a pore size between about 30 and about 70 microns, and a porosity of between about 10% and about 50%, for example. Other hardness, pore sizes, and porosities may be used.

In some embodiments, the disc-shaped platen 106 may be rotated at between about 10 and about 200 RPM, between about 20 RPM and about 120 RPM, and between about 50 RPM and about 100 RPM in some embodiments while polishing, i.e., a material-removal process wherein the metal layer on the substrate 102 is planarized by using a slurry containing an abrasive and possibly an etchant.

The substrate 102 may be held in a substrate holder 108 including a retaining ring 110 (shown in cross-section). Prior art substrate holders (also referred to as retainers or carrier heads) are described in U.S. Pat. No. 8,298,047; U.S. Pat. No. 8,088,299; U.S. Pat. No. 7,883,397; and U.S. Pat. No. 7,459,057, issued to the present assignee, for example, and incorporated herein by reference. Other types of substrate holders may be used. Substrate holder 108 may be rotated and may also be scanned (e.g., oscillated) back and forth across the surface of the polishing pad 104 as the polishing pad 104 is being rotated in contact with the substrate 102. The holder oscillation rate may between about 0.1 mm/s and about 5 mm/s, for example. Other oscillation rates may be used. Substrate holder 108 may be rotated at between about 10 RPM to about 200 RPM.

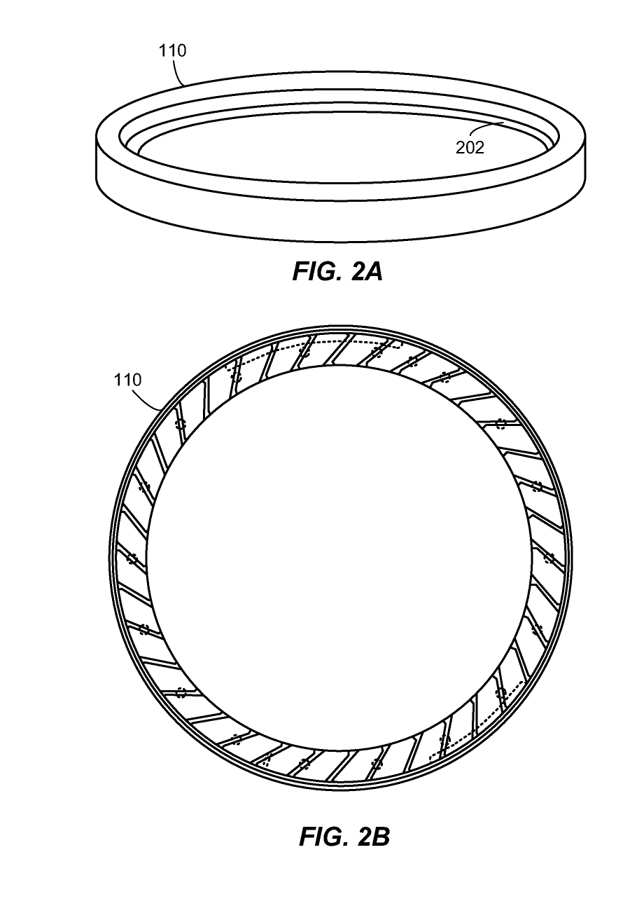

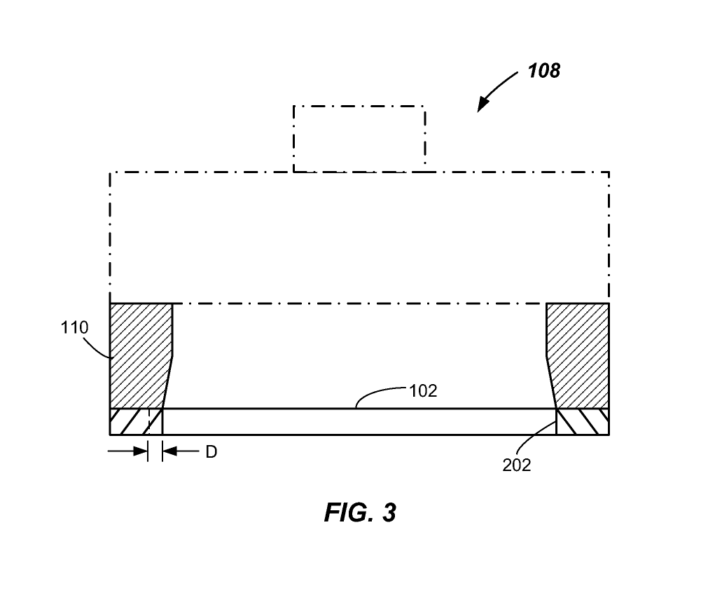

Turning now to FIGS. 2A and 2B, perspective and top plan views of a substrate retaining ring 110 for the substrate holder 108 are shown. Note that inner surface 202 is the surface that contacts the outer edge of the substrate 102 (i.e., the contact portion supporting the peripheral edge of the substrate 102). This is the surface 202 that is hardened relative to the remainder of the retaining ring to reduce the chance of notching. FIG. 3 depicts a cross-sectional view of the retaining ring 110 with the remainder of the substrate holder 108 shown in phantom. In some embodiments, the retaining ring can be constructed of a polymer material, for example, polyphenylene sulfide (PPS) plastic. Other materials can be used. Dimension “D” represents the depth to which the inner surface 202 of the retaining ring 110 has been hardened. In some embodiments, the increased hardness is hardened to a depth D of at least greater than 0.1 mm. In some embodiments, the polymer contact portion (i.e., inner surface 202 or inner diameter) has a hardness that is at least five percent (5%) greater than the remaining portion of the polymer retaining ring. In some embodiments, the greater hardness and depth D of the inner diameter of the polymer retaining ring 110 is substantially uniform around the ring 110.

In some embodiments, the greater hardness is provided by exposing the inner surface 202 to UV light for a sufficient time to cure and harden the inner surface 202 to a depth D. In such embodiments, the portions not to be hardened may be taped to prevent other regions of the polymer retaining ring 110 from being exposed to UV light and hardened in those regions. In alternative embodiments, greater hardness is provided by exposing the inner diameter to bead blasting for a sufficient time to compact and harden the inner surface 202 to a depth D.

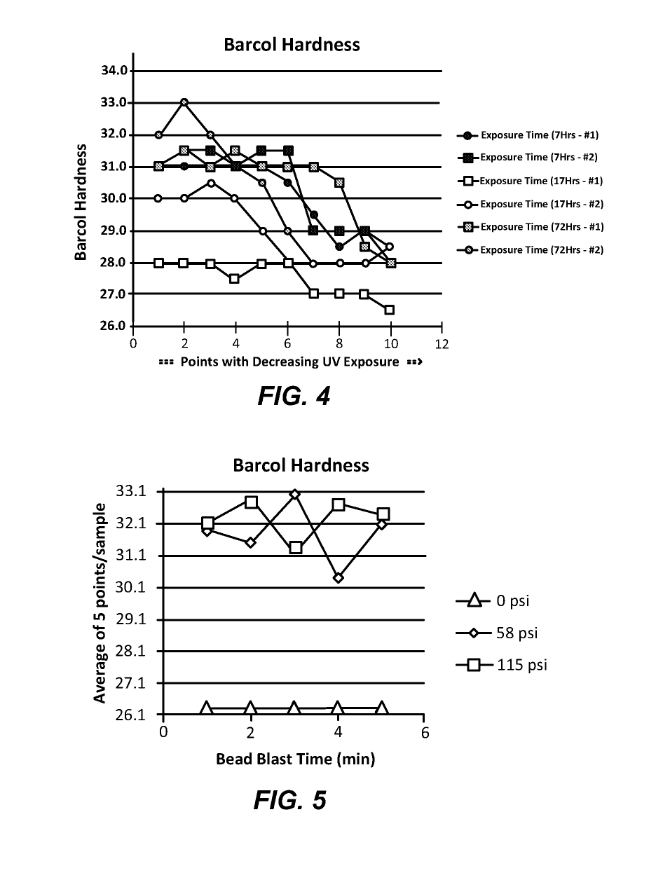

FIG. 4 depicts an example graph of Barcol hardness versus ultraviolet (UV) light exposure time and FIG. 5 depicts an example graph of Barcol hardness versus bead blast time. These graphs illustrate the hardening effects of UV light curing and bead blasting, respectively, on the surface of PPS plastic. More specifically, FIG. 4 shows that there is a correlation between UV exposure and polymer (PPS) hardness. This graph may also show that there is a correlation between UV exposure (intensity) vs. polymer (PPS) hardness and little to no correlation between UV exposure (time) vs. polymer (PPS) hardness. In addition, the graph of FIG. 5 appears to show that there is little to no correlation between bead blast (pressure or time) vs. polymer (PPS) hardness.

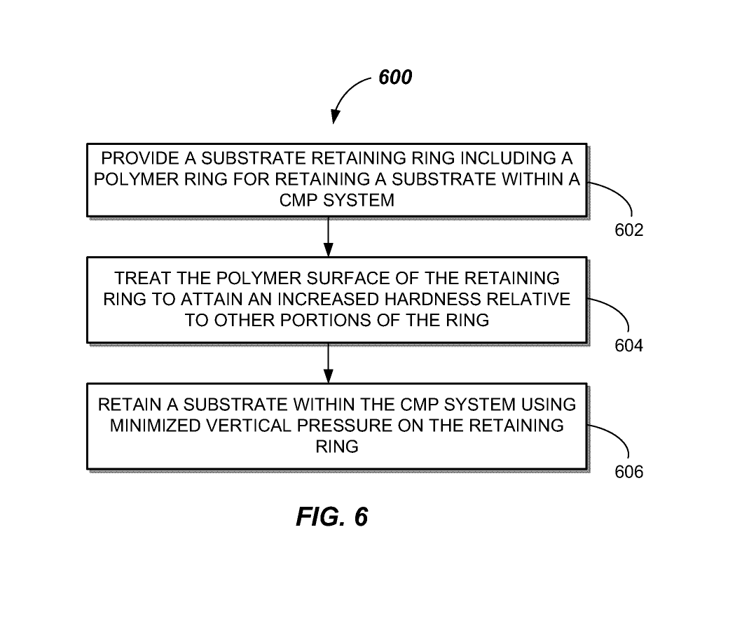

FIG. 6 illustrates an example embodiment of a chemical mechanical polishing method 600 adapted to process a substrate (e.g., substrate 102), and in particular a method of using a substrate holder 108 including a retaining ring 110 with a hardened inner surface 202 to prevent notching and to reduce the amount of vertical wear required to securely retain the substrate 102.

The example method 600 includes providing a substrate retaining ring including a polymer ring for retaining a substrate within a CMP system (602). An inner surface of the retaining ring is treated to attain an increased or greater hardness relative to other portions of the ring (604). The treatment may include UV light curing, bead blasting, or other methods of hardening a surface. The hardened retaining ring is then used to retain a substrate within the CMP system while allowing the vertical pressure and thus, the vertical wear on the ring to be minimized (606).

Accordingly, while the present invention has been disclosed in connection with example embodiments thereof, it should be understood that other embodiments may fall within the scope of the invention, as defined by the following claims.

The invention claimed is:

1. A chemical mechanical processing system, comprising:
a substrate held in a substrate holder having a substrate retaining ring, the substrate having a peripheral edge supported by the substrate retaining ring, the retaining ring having a polymer ring having a polymer contact portion in contact with at least a portion of the peripheral edge, wherein the polymer contact portion has a hardness that is greater than a remaining portion of the polymer ring.

2. The chemical mechanical polishing system of claim 1, wherein the polymer contact portion has a hardness that is at least 5% greater than the remaining portion of the polymer ring.

3. The chemical mechanical polishing system of claim 1, wherein an inner diameter of the polymer ring is hardened.

4. The chemical mechanical polishing system of claim 1, wherein the greater hardness is hardened to a depth of at least greater than 0.1 mm.

5. The chemical mechanical polishing system of claim 1, wherein the greater hardness of an inner diameter of the polymer ring is substantially uniform.

6. The chemical mechanical polishing system of claim 1, wherein the greater hardness is provided by exposing the inner diameter to UV light for a sufficient time.

7. The chemical mechanical polishing system of claim 1, wherein the greater hardness is provided by exposing the inner diameter to bead blasting for a sufficient time.

8. A substrate processing method, comprising:
providing a substrate retaining ring including a polymer ring having a polymer surface adapted to contact a substrate while in operation; and
treating the surface of the polymer ring to attain an increased hardness of the surface as compared to other regions of the polymer ring.

9. The method of claim 8, wherein treating the surface includes exposing the surface to UV light.

10. The method of claim 8, wherein treating the surface includes covering portions of the polymer ring and exposing the uncovered portions to UV light.

11. The method of claim 8, wherein treating the surface includes hardening the surface.

12. The method of claim 8, wherein treating the surface includes bead blasting the polymer surface.

13. The method of claim 8, wherein treating the surface includes treating the polymer surface to a predetermined depth.

14. The method of claim 8, wherein treating the surface includes treating the polymer surface to a predetermined hardness.

15. A substrate holder comprising:
a substrate retaining ring configured to support a peripheral edge of a substrate, the retaining ring including a polymer ring having a polymer contact portion adapted to contact at least a portion of the peripheral edge, wherein the polymer contact portion has a hardness that is greater than a remaining portion of the polymer ring.

16. The substrate holder of claim 15, wherein the polymer contact portion has a hardness that is at least 5% greater than the remaining portion of the polymer ring.

17. The substrate holder of claim 15, wherein the greater hardness is hardened to a depth of at least greater than 0.1 mm.

18. The substrate holder of claim 15, wherein the greater hardness of an inner diameter of the polymer ring is substantially uniform.

19. The substrate holder of claim 15, wherein the greater hardness is provided by exposing the inner diameter to UV light for a sufficient time.

20. The substrate holder of claim 15, wherein the greater hardness is provided by exposing the inner diameter to bead blasting for a sufficient time.
